(19) United States
(12) Patent Application Publication
(10) Pub. No.: US 2011/0307304 A1
(43) Pub. Date: Dec. 15, 2011

(54) CROWD-SOURCED COMPETITION PLATFORM

(75) Inventor: Marc E. Mercuri, Bothell, WA (US)

(73) Assignee: MICROSOFT CORPORATION, Redmond, WA (US)

(21) Appl. No.: 12/813,510

(22) Filed: Jun. 11, 2010

(51) Int. Cl. G06Q 10/00; G06F 17/30

(52) U.S. Cl. 705/12; 707/748; 705/300; 707/E17.044

(57) ABSTRACT

A crowdsourcing competition system is described herein that provides a reusable mechanism by which an organization can host a cloud-based crowdsourcing competition. The system facilitates identification of individuals, forums, submission of user-generated content (challenge submissions), automated scoring of user-generated content against test sets, automated outbound communication to participants, and web services for leaderboard functionality. The system provides workflows for users to submit submissions and for the system to receive and organize submissions. Thus, the crowdsourcing competition system provides a generic platform and automated workflow for holding crowd-sourced competitions and automating workflow of user generated content submissions.

### BACKGROUND

Organizations often have large volumes of work to be performed, sometimes larger than what their employee base can handle. A common solution is to hire temporary workers to temporarily scale up capacity to handle a particular task. Tasks may cover a wide range of activities. For example, a website that receives photos may want to have the photos reviewed for harmful content. An organization that receives essay submissions may want an initial quality check to determine that the submissions adhere to a specified format. These tasks may be centered on events that create brief busy periods, such as a holiday shopping season. It is often inefficient for the organization to grow in size over the long term to meet short-term needs.

Crowdsourcing refers to leveraging crowds of people, usually in an online setting, that have idle time or available time to perform a task. The convergence of the cloud and the crowd provides an organization an opportunity to engage a significant number of people to help solve difficult problems. One approach to this is for an organization to launch a competition. Via the competition, the organization asks people to perform a task and provide submissions related to the task. For example, an organization with a new application-programming interface (API) may enlist developers to create applications based on its APIs and/or data. The developers create applications that performed a task or set of tasks that provide significant value to the organization.

Although crowdsourcing promises to provide enormous capacity and flexibility to organizations on relatively short notice, organizing the participants and evaluating submissions proves to be a daunting task in itself. Today, there is no software infrastructure code available to handle the needs of these types of competitions, and the software is created new by each organization that hosts one. Organizations typically develop a website from scratch, as well as scoring systems, content submission workflows, communication with participants (e.g., email or other notifications), and so forth. Because most organizations do not natively have the expertise for this type of development and few third party developers exist to which to outsource this type of work, organizations often end up not using crowdsourcing as frequently or effectively as is possible.

### SUMMARY

A crowdsourcing competition system is described herein that provides a reusable mechanism by which an organization can host a cloud-based crowdsourcing competition. The system facilitates identification of individuals, forums, submission of user-generated content (challenge submissions), automated scoring of user-generated content against test sets, automated outbound communication to participants, and web services for leaderboard functionality. The system provides workflows for users to submit submissions and for the system to receive and organize submissions. Thus, the crowdsourcing competition system provides a generic platform and automated workflow for holding crowd-sourced competitions and automating workflow of user generated content submissions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the crowdsourcing competition system, in one embodiment.

FIG. 2 is a flow diagram that illustrates processing of the crowdsourcing competition system to manage a competition, in one embodiment.

FIG. 3 is a flow diagram that illustrates processing of the crowdsourcing competition system to receive a content submission, in one embodiment.

### DETAILED DESCRIPTION

A crowdsourcing competition system is described herein that provides a reusable mechanism by which an organization can host a cloud-based crowdsourcing competition. The system facilitates identification of individuals, forums, submission of user-generated content (challenge submissions), automated scoring of user-generated content against test sets, automated outbound communication to participants, and web services for leaderboard functionality. The ability to identify participants is useful for rewarding successful participants (e.g., a contest winner), detecting duplicate submissions, or detecting users trying to get around established limits by posing as another user, and so forth. The crowdsourcing competition system provides an identify facility that issues an identity to each user. For example, the system may provide a federated third party identity (e.g., a MICROSOFT™ Live ID, Google ID, and so forth). The system provides workflows for users to submit submissions and for the system to receive and organize submissions. Submissions may include any type of data appropriate for a particular type of competition. For example, a logo design competition may include submitted images of proposed logos.

The system provides a scoring facility for evaluating each submission based on quality. The scoring may include automated and manual components, depending on the submission types and qualities of the submissions to be evaluated. The crowdsourcing competition system provides a user communication facility for handling status updates, confirmations of submissions, winner notifications, and other communications with participants. The system provides a leaderboard facility that displays each participant's comparative rank with respect to other participants and fosters competitiveness that may lead to higher quality submissions. The system also includes a reporting facility for communicating statistics about the competition to a competition organizer. Thus, the crowdsourcing competition system provides a generic platform and automated workflow for holding crowd-sourced competitions and automating workflow of user generated content submissions.

The crowdsourcing competition system provides a generic, customizable approach to the facilitation of crowdsourcing competitions, inclusive of identity, submission of content, and receipt of content. A participant has an identity that is used in the system. The identity is either directly issued by a third party (e.g., a government or employer) or contains information that allows it to be federated or associated with third party identities (e.g., govID, LiveID, Open ID, GoogleID, and so forth). Submitting an entry provides the identity of the individual/team submitting the entry, the content for the submission, and any additional metadata (e.g., a URL for a cloud-hosted application).

Depending on the rules of a particular competition, a participant may be allowed to make only one submission over the life of the competition (i.e., a final submission), or multiple test submissions over the course of the competition. Test submissions allow users to submit the results of their applications against a test set of data, with the theory being that this provides insight into how their application would perform against the complete data set. The crowdsourcing competition system supports the option to support final submissions as well as submissions against multiple test file sets. In addition, trial submissions can be limited to a pre-determined amount of submissions per period (e.g., once per day). When selecting a file, the user identifies a file set (final, trial0, trial1, and so on) against which the submitted file will be scored.

A sample client user interface is provided that facilitates the collection of all of these pieces of information, and the user interface is connected to a set of cloud-based web services. Upon collecting the data, the client passes metadata and submission content to a cloud-based web service. Upon receipt of the submission, the system creates a distinguishing identifier for the submission and stores any associated files and metadata. Once stored, the system follows a workflow that applies any rules or limits associated with the competition. For example, has the user already submitted a threshold number of entries for the given period? If yes, the system may generate a notification (e.g., an email) that indicates the identifier for the submission, text that identifies that the entry will not be scored, and contact information for more information. If the user has not exceeded the threshold number of entries, the format of the file is evaluated. If the format of the file is invalid, the system generates a communication indicating the identifier for the submission, that the file was in the wrong format and cannot be scored, and contact information for more information. If the file format is valid and the user has not exceeded the threshold number of entries, the submission is scored and the user may receive a communication indicating that the system accepted the submission.

The crowdsourcing competition system provides a pluggable framework that allows each challenge creator to create classes that represent their specific answer sets and evaluation logic. By default, the system will evaluate submissions against a given test data set, incrementing/decrementing the participant's score based on correct/incorrect submission content. Once scoring is complete, the system generates a communication indicating the identifier for the submission, the score assigned, and contact information for more information. In some embodiments, all routes of the submission workflow result in the transmission of an email to the participant. Using the email address associated with the submitting user, an email is sent containing the email text created during the submission workflow to indicate an outcome of the submission.

As with real world competitions, there is an interest in users ranking themselves against other users in a leaderboard. The crowdsourcing competition system includes web services that provide this functionality, returning paged leaderboard data that identifies a total score, as well as scores for any trial sets measured against. The crowdsourcing competition system also provides reporting, with the ability to identify number of submissions, number of submissions per period, average percent accurate per team, average percent accurate per trial set, and other useful metrics for the competition organizer.

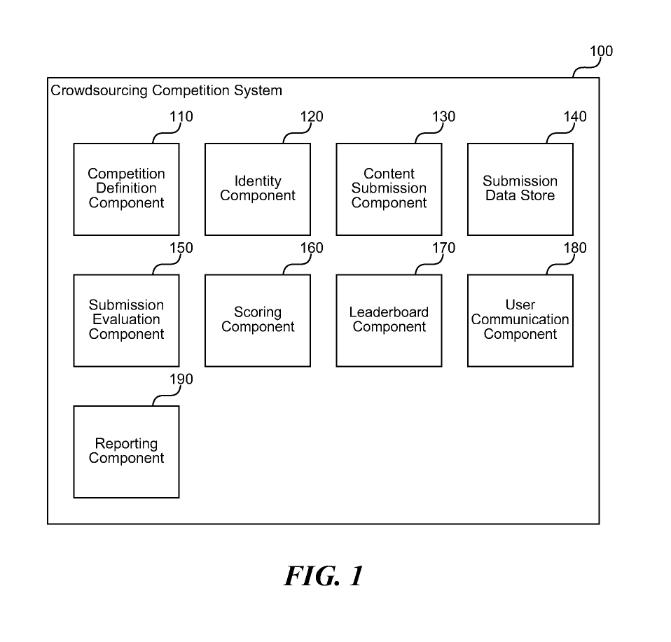

FIG. 1 is a block diagram that illustrates components of the crowdsourcing competition system, in one embodiment. The system 100 includes a competition definition component 110, an identity component 120, a content submission component 130, a submission data store 140, a submission evaluation component 150, a scoring component 160, a leaderboard component 170, a user communication component 180, and a reporting component 190. Each of these components is described in further detail herein.

The competition definition component 110 receives information describing a competition from a competition organizer. The information may include limits regarding competition submissions (e.g., number of submissions per participant, rate of submissions per period, size limits of submissions, and so forth). The information may also include theming information for branding a competition with logos, colors, fonts, or other theming associated with the competition organizer as well as a domain or other web address associated with the competition. The competition definition component 110 may receive information for communications related to the competition, such as email templates that the organizer would like to use for communicating with competition participants. The email templates may include contact information for the organizer, rules of the competition, or other information determined by the organizer. The competition definition component 110 stores competition information in a data store for later retrieval when participants join the competition or send submissions.

The identity component 120 associates a digital identity with each competition participant and verifies the digital identity of participants upon receiving an action from the participant. For example, the system may leverage an existing identity provider (e.g., an Internet Service Provider or email host) or create identities of its own (e.g. associated with an email address, credit card, or other external identity). The system 100 uses the digital identity to audit content submissions and to enforce any limits specified in the competition definition, such as limits on a number of allowed submissions per day per participant. The identity component 120 may include a user interface such as a login page that receives a username and password or other proof of a participant's identity.

The content submission component 130 receives submissions from competition participants related to a goal of the competition. For example, a competition to identify faces in a photo data set may include a mapping of photos to identities of individuals in the photos. The competition organizer may provide a test data set that competition participants can use to test their solutions against prior to submission. The organizer may have goals such as speed of recognition, accuracy of matches, and other criteria against which submissions are scored by the system 100. The content submission component 130 may provide a user interface such as a web page for uploading a submission as well as programmatic interfaces, such as a web services API for providing submissions. The content submission component 130 stores received submissions in the submission data store 140.

The submission data store 140 stores information about competitions and content submissions as the submissions proceed through a workflow processed by the system 100. The submission data store 140 may include one or more files, file systems, databases, cloud-based storage services, or other storage facilities for persisting data across user sessions with the system 100. The submission data store 140 may track a state or status for each submission as well as each identified participant for moving items through the workflow similar to a state machine. Other components update the submission data store 140 as submissions are scored, accepted, rejected, and when submissions place in the competition.

The submission evaluation component 150 evaluates submissions for adherence to one or more competition rules. The rules provided with the competition definition may include limits on the size of submissions, number of submissions per participant in total or over a period, error rate compared to a test data set, and so forth. The submission evaluation component 150 determines whether a submission meets a threshold level of quality and correctness before marking the submission for comprehensive evaluation. If the submission is defective in any way, the submission evaluation component 150 invokes the user communication component 180 to inform the participant that provided the submission so that the participant can make corrections. The submission evaluation component 150 may also provide a user communication upon acceptance of a submission.

The scoring component 160 assigns a qualitative score to each accepted submission. After the submission evaluation component 150 indicates that a submission is valid, the scoring component 160 determines where the submission ranks on a qualitative scale. The scale may be selectable by the competition organizer and may include enumerated tags (e.g., good, better, best), numeric scores (e.g., 1 to 100), or other scalable indications of a score or rank compared to other submissions. For some competitions, the organizer may align scoring with a theme of the competition, such as by using ranks for a military related competition (e.g., sergeant, colonel, general). Thus, competition participants may obtain bragging rights with their friends based on the value and quality of their submissions to the competition organizer. The scoring component 160 stores the score in the submission data store 140 and may send a communication to the participant to indicate the score. The system may score submissions by comparing the submission to a test data set provided by the competition organizer, by a rate of execution or the submission, or by other criteria established by the competition organizer.

The leaderboard component 170 maintains a leaderboard that ranks competition participants based on scoring of their submissions. The leaderboard may include subdivisions, such as a rank by first submission, average score per participant, highest score for each participant, earliest provided solution, and so forth. There can also be multiple tiers of competition, such as professional or amateur, age ranges, and so on. The leaderboard changes over time as new participants provide higher scoring submissions that outrank previous submissions of participants on the leaderboard. In some embodiments, the system 100 provides a cross-competition leaderboard for participants that are active in multiple competitions. Because the system 100 provides a generic platform for hosting competitions and competitions may involve similar participants, some participants will be interested over time in seeing how they compare across competitions to other participants. Based on configuration information from the competition organizer, the system 100 may share scores across competitions to provide a cross-competition leaderboard.

The user communication component 180 sends communications to competition participants. The user communication component 180 may send messages from the system to participants, from participants to other participants, from the organizer to participants, and so forth. The system 100 may use a variety of communication protocols, such as sending email, short message service (SMS) messages, and so forth. The user communication component 180 keeps participants informed about the status of their submissions, the status of the overall competition, and so on. The system 100 can receive customized communication templates from competition organizers, but also provides default templates for communication if no custom templates are provided. This allows competition organizers to quickly setup a competition but also to invest in as much customization as they choose.

The reporting component 190 gathers and reports statistical information to the competition organizer. For example, the system may track how many participants have entered the competition, average submissions per participant, time between submissions for each participant, quality of submissions, and so forth. In some embodiments, the system 100 uses the gathered statistics to modify the competition. For example, the system 100 or an organizer may determine that extending the competition for two days will result in 100 more submissions of increasing quality. The reporting component 190 also allows the competition organizer to select a competition winner (and other placing participants, such as second, third, fastest solution, and so on). In some embodiments, the system 100 operator and the competition organizer have contractual payment terms tied to reported statistical information. For example, the competition organizer may pay the system operator a fee per submission, or a weighted fee based on submission quality.

The computing device on which the crowdsourcing competition system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

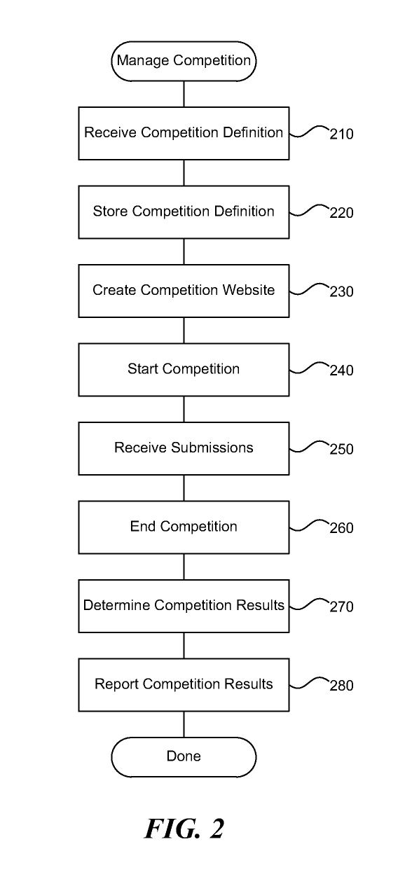

FIG. 2 is a flow diagram that illustrates processing of the crowdsourcing competition system to manage a competition, in one embodiment. Beginning in block 210, the system receives from a competition organizer a competition definition that provides information about the competition. In some embodiments, the system provides a generic competition platform that organizers can customize to use the platform for custom competitions. The competition definition specifies information about a custom competition, such as a logo/name associated with the competition, competition rules, a duration of the competition, any limits on submissions or entries, and so forth. Based on the competition definition, the system configures the platform to support a particular organizer's competition.

Continuing in block 220, the system stores the competition definition in a data store. The system refers to the competition definition when participants access a website related to the competition, submit entries in the competition, or receive communications from the system. For example, when a participant accesses the website, the system may access branding information to display on the website to the participant. When a participant submits an entry, the system uses the competition definition to apply any rules or limitations on submissions. When the system communicates with participants, the system may access any email templates provided by the competition organizer.

Continuing in block 230, the system creates an application to host a competition in accordance with the received competition definition. The application may include a web application (e.g., a website) or other type of application, such as a mobile phone application. The system provides web pages and other interfaces for hosting competitions, and the application created by the system provides access to the competition system by participants. The system may also provide an administrative website or other interface through which competition organizers can view reporting information and configure competition settings.

Continuing in block 240, the system starts the competition by opening the website to participant registration and submissions. Based on the competition definition, the system may run the competition during a specified period. In some cases, organizers may tie competitions to particular events (e.g., a pre-Labor Day competition or a competition prior to the finale of a television show). In some embodiments, the system may allow the competition organizer to direct the system to send invitations to join the competition to particular participants. For example, the organizer may have an email list of customers or a list of past competition participants that the organizer wants to invite to a current competition.

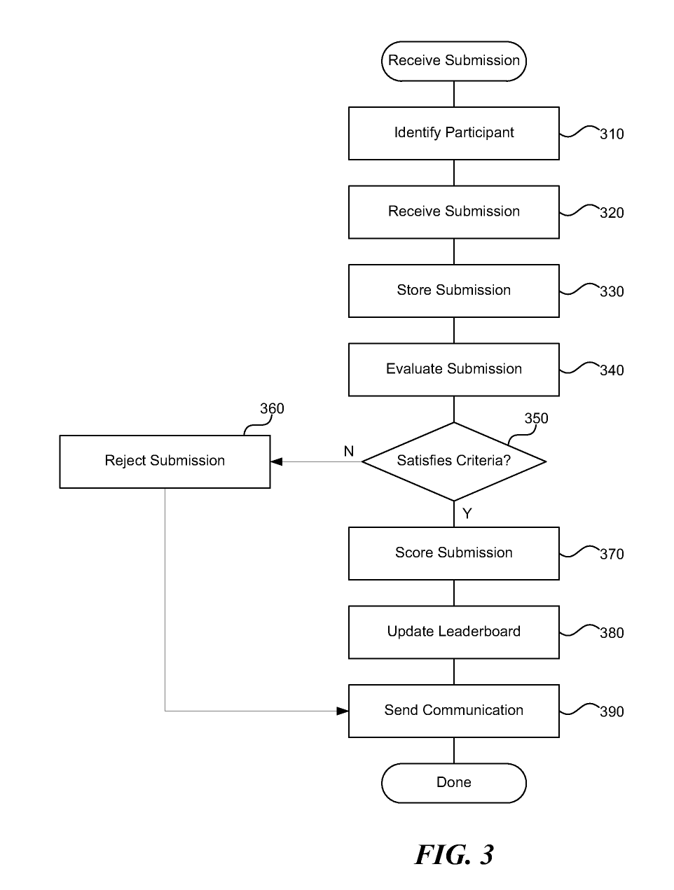

Continuing in block 250, the system receives one or more submissions related to the competition from one or more competition participants. The content of the submissions may vary based on the type of competition, and may include images, computer software code, data set results, or any other type of data related to the competition. The competition organizer may configure the system to accept particular data types and reject other data types. For example, a particular competition may be configured to accept image files but not executable files. The process of receiving an individual submission is described further herein with reference to FIG. 3.

Continuing in block 260, the system ends the competition by closing the website to new submissions. In some embodiments, the system may notify participants when the competition is over as well as at some interval before the competition is over (e.g., one more week to enter submissions). The system may keep the website up for some time after the competition to present competition results, allow participants to view final leaderboards, and so forth.

Continuing in block 270, the system determines one or more competition winners based on criteria provided in the competition definition. In some embodiments, the system may use automated objective criteria for identifying a winner, manual subjective criteria, or some combination of the two. For example, for a software coding competition the system may declare as a winner the participant that submits code that runs the fastest and produces a correct test data set. In other competitions, the competition organizer may manually inform the system of a winner or may award points that contribute to a total score that automatically determines a winner. For some competitions, the crowd itself may determine a winner based on peer voting and other methods, or may award points (e.g., style points) that contribute to a score for determining a winner. Competitions may have multiple winners or multiple places (e.g., 1st, 2nd, and 3rd place) awarded to participants.

Continuing in block 280, the system reports results of the competition to participants. The system may also notify the competition organizer when the competition is complete and a winner is determined. In some cases, the organizer may have follow up obligations based on the winner, such as awarding prizes, arranging for travel for a free trip associated with the competition, and so forth. The system may send an email or other notification to competition participants announcing the winner or winners. After block 280, these steps conclude.

FIG. 3 is a flow diagram that illustrates processing of the crowdsourcing competition system to receive a content submission, in one embodiment. Beginning in block 310, the system identifies a participant from which to receive the content submission. For example, the participant may log onto a website associated with a competition to submit a data set or other results of the participant's work related to the competition. The system may provide an identifier to each participant or may rely on a third party identity provider to identify each participant. In some embodiments, the system verifies a certificate, token, or other provided authentication information to determine an identity associated with the participant.

Continuing in block 320, the system receives a submission associated with the participant, wherein the submission is a type of data associated with the competition. Each competition may define different types or formats to which submissions are limited, and the system may enforce rules related to submissions to ensure that submissions are of a high level of quality. The submission may also include metadata, such as a cloud-based location where the submission is stored, other participants for team-based submissions, an answer set against which to evaluate a submission, and so on. Continuing in block 330, the system stores the received submission for processing in a workflow that handles evaluation of the submission for the competition. For example, the system may tag and store each submission in a database and associate a status with the submission that indicates a present state in the workflow for competition submissions. The system may also provide a confirmation number or other identifier to the participant as a receipt for the submission and for later auditing of any problems with the submission process.

Continuing in block 340, the system evaluates the received submission to determine whether the submission meets threshold criteria for quality associated with the competition. For example, a competition organizer may specify limits on submission size (e.g., file size, word count, and so forth), file types or content types allowed for submissions, data to be included with a submission, and so on. In decision block 350, if the system determines that the submission meets the threshold criteria, then the system continues at block 370, else the system continues at block 360. Continuing in block 360, the system rejects the submission and sends a communication to the participant indicating that the submission is rejected. The system may continue to store rejected submissions and allow participants to edit the submissions to make corrections to the submission so that the submission meets the criteria. The system may also allow the participant to make a new submission to replace a rejected submission, so that a rejected submission does not count against any submission limit established by the competition organizer.

Continuing in block 370, the system determines a score for the received submission that indicates where the submission ranks compared to other submissions. The system may determine the score based on a variety of factors, such as size of the submission, quality of a test data set output by the submission, resource usage of the submission, and so forth. A score range may be determined by the competition organizer and configured with the system, and the system may assign scores based on rules provided by the competition organizer. For example, an organizer can establish a score range of 0-10, and indicate how points are distributed within the range. Continuing in block 380, the system updates a leaderboard associated with the competition to rank a participant against other participants based on the determined score for the received submission. The leaderboard may include rankings for participants by submission, based on an average of submission scores, and on other criteria established by the competition organizer.

Continuing in block 390, the system sends a communication to the participant indicating a disposition of the received submission. For example, the communication may indicate whether the submission was accepted or rejected, what score the submission received, where the participant is currently ranked on the leaderboard, and so forth. After block 390, these steps conclude.

In some embodiments, the crowdsourcing competition system provides one or more web services that a competition organizer can leverage to build a competition website. The system may provide identity, content submission, scoring, reporting, and other facilities as services of a platform, whereas the competition organizer may provide a user interface that invokes the web services at appropriate times. In other embodiments, the system provides an end-to-end solution including a user interface, and the competition organizer provides data-driven customizations, such as branding and logos.

In some embodiments, the crowdsourcing competition system stores content submissions and other data using a cloud-based storage service. For example, MICROSOFT™ Azure, Amazon Web Services, and other platforms provide storage services that a web site or other application can invoke to store data. The system can store participant content submissions using such services, and access the content submissions at various stages of a content evaluation workflow. The system may encrypt or otherwise protect stored content to prevent unwanted access to data.

In some embodiments, the crowdsourcing competition system provides participants with an identity that spans competitions. Over time, a participant may build up a reputation for high participation and effective submissions. The participant can include the information on a resume or bio that shows others the participant's skills. Providing this information also incentivizes participants to use the system, as they build up a reputation across competitions and in a manner that endures beyond the lifetime of any single competition. The system may also provide leaderboards and reporting that spans competitions, so that participants can measure performance over time and can compete on an ongoing basis.

In some embodiments, the crowdsourcing competition system is provided as a deployable virtual machine instance. Cloud-based services such as MICROSOFT™ Azure and Amazon EC2 often provide deployable instances that represent pre-configured machines or groups of machines ready for specific purposes. For example, services may provide an email server or web server instance. The crowdsourcing competition system can also be provided as a deployable instance, where the competition organizer can modify settings that affect the look and feel, text, and rules of a competition and then have a ready to use web server for hosting the competition.

In some embodiments, the crowdsourcing competition system provides a mobile application for monitoring status and participating in competitions. Mobile devices such as MICROSOFT™ WINDOWS™ 7 phones, Apple iPhones and iPads, Google Android phones, and others allow users to install applications that perform a variety of tasks. The competition organizer can provide a branded application for monitoring a particular competition and the system operator can provide an application for monitoring multiple competitions that use the system from mobile devices. The system may also provide integration with online services such as Facebook, Twitter, or others to post a participant's status and to let the participant's friends know that the participant is a member of the competition.

From the foregoing, it will be appreciated that specific embodiments of the crowdsourcing competition system have been described herein for purposes of illustration, but that various modifications may be made without deviating from the spirit and scope of the invention. Accordingly, the invention is not limited except as by the appended claims.

I/We claim:

1. A computer-implemented method for managing an online competition, the method comprising:
receiving from a competition organizer a competition definition that provides information about the competition;
storing the competition definition in a data store;
creating a an application to host a competition in accordance with the received competition definition;
starting the competition by opening the application to participant registration and submissions;
receiving one or more submissions related to the competition from one or more competition participants;
ending the competition by closing the application to new submissions;
determining one or more competition winners based on criteria provided in the competition definition; and
reporting results of the competition to competition participants,
wherein the preceding steps are performed by at least one processor.

2. The method of claim 1 wherein receiving the competition definition comprises providing a generic competition platform that organizers can customize to use the platform for custom competitions.

3. The method of claim 1 wherein receiving the competition definition comprises receiving branding information and rules that identify one or more limits on submissions related to the competition.

4. The method of claim 1 wherein storing the competition definition comprises accessing a cloud-based storage service to refer to the competition definition as participants access a website related to the competition, submit entries in the competition, and receive communications from the system.

5. The method of claim 1 wherein creating the web site comprises providing one or more web pages for hosting the competition that provide access to the competition to competition participants.

6. The method of claim 1 wherein creating the application comprises providing an administrative website through which the competition organizer can view reporting information and configure competition settings.

7. The method of claim 1 wherein starting the competition comprises applying one or more rules specified by the received competition definition to run the competition during a specified period.

8. The method of claim 1 wherein receiving one or more submissions comprises determining that the competition organizer has configured the system to accept particular data types and reject other data types.

9. The method of claim 1 wherein ending the competition comprises notifying participants that the competition is complete.

10. The method of claim 1 wherein determining one or more competition winners comprises using automated objective criteria for identifying a winner based on received content submissions.

11. The method of claim 1 wherein determining one or more competition winners comprises notifying a competition organizer to select a winner and receiving one or more selections from the competition organizer.

12. The method of claim 1 wherein determining one or more competition winners comprises notifying one or more competition participants to vote for one or more competition winners.

13. The method of claim 1 wherein reporting results comprises notifying the competition organizer that the competition is complete and a winner has been determined.

14. A computer system that provides a platform for hosting online competitions, the system comprising:
a processor and memory configured to execute software instructions;
a competition definition component configured to receive information describing a competition from a competition organizer;
an identity component configured to associate a digital identity with each competition participant and verify the digital identity of participants upon receiving an action from a participant;
a content submission component configured to receive submissions from competition participants related to a goal of the competition;
a submission data store configured to store information about competitions and content submissions as the submissions proceed through a workflow processed by the system;
a submission evaluation component configured to evaluate submissions for adherence to one or more competition rules provided with the competition definition;
a scoring component configured to assign a qualitative score to each accepted submission;
a leaderboard component configured to maintain a leaderboard that ranks competition participants based on scoring of their submissions;
a user communication component configured to send communications to competition participants; and
a reporting component configured to gather and report statistical information to the competition organizer.

15. The system of claim 14 wherein the competition definition components is further configured to receive limits regarding competition submissions and theming information for branding a competition.

16. The system of claim 14 wherein the identity component is further configured to access an existing identity provider to use an existing digital identity for a participant to access the system.

17. The system of claim 14 wherein the content submission component is further configured to receive a test data set from the competition organizer and a result set with each content submission with which to compare the test data set.

18. The system of claim 14 wherein the system provides a generic platform for hosting competitions and the leaderboard component is further configured to provide at least one leaderboard that spans multiple competitions.

19. A computer-readable storage medium comprising instructions for controlling a computer system to receive a content submission for a crowd-sourced competition, wherein the instructions, upon execution, cause a processor to perform actions comprising:
identifying a participant from which to receive the content submission;
receiving a submission associated with the participant, wherein the submission is a type of data associated with the competition;
storing the received submission for processing in a workflow that handles evaluation of the submission for the competition;
evaluating the received submission to determine whether the submission meets threshold criteria for quality associated with the competition;
determining a score for the received submission that indicates where the submission ranks compared to other submissions;
updating a leaderboard associated with the competition to rank a participant against other participants based on the determined score for the received submission; and
sending a communication to the participant indicating a disposition of the received submission.

20. The medium of claim 19 further comprising, upon determining that the received submission does not meet threshold criteria, rejecting the submission and sending a communication to the participant indicating that the submission is rejected.
